(19) United States
(12) Patent Application Publication
(10) Pub. No.: US 2026/0320076 A1
(43) Pub. Date: Oct. 15, 2026

(54) METHOD AND APPARATUS FOR DISTRIBUTED UNSTRUCTURED DATA-PLANE IN A WIRELESS COMMUNICATION SYSTEM

(71) Applicant: Samsung Electronics Co., Ltd., Suwon-si, Gyeonggi-do (KR)

(72) Inventors: Deval BHAMARE, Staines (GB); Yue WANG, Staines (GB)

(21) Appl. No.: 19/475,296

(22) PCT Filed: Apr. 12, 2024
(86) PCT No.: PCT/KR2024/004946

§ 371 Date: Oct. 14, 2025

(30) Foreign Application Priority Data
Apr. 14, 2023 (GB) 2305549.4
Mar. 4, 2024 (GB) 2403087.6

(51) Int. Cl. G06F 16/27; H04L 67/1031; H04L 67/1097

(52) U.S. Cl. CPC G06F 16/278; H04L 67/1031; H04L 67/1097

(57) ABSTRACT

The disclosure relates to a 5G or 6G communication system for supporting a higher data transmission rate.

### TECHNICAL FIELD

The technical field relates generally to implementing techniques to supporting data-plane data transfer and storage. In particular, the technical field relates to transfer and storage of data in an unstructured data-plane using distributed database.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

At the present time, the following standards exist: 3GPP Technical Specification Group Services and System Aspects, “3GPP TS 29.598: Unstructured data storage services,” Technical Specification version 15.3.0 Release 15; 3GPP Technical Specification Group Services and System Aspects, “3GPP TS 23.501: System architecture for the 5G System (5GS) Stage 2 (Release 17) v. 17.6.0,” Technical Specification, October 2022; 3GPP Technical Specification Group Services and System Aspects, “3GPP TS 23.502: Procedures for the 5G System (5GS) Stage 2 (Release 17) v.17.6.0,” Technical Specification, October 2022.

In recent years, there has been a rapid development in communications technologies that are compliant with third generation partnership project (3GPP) standards. A 4^{th} generation (4G) wireless communication standard (sometimes referred to as long term evolution (LTE)) was designed to support mobile internet and higher speeds for activities, such as video streaming and gaming. The 3GPP standards then developed a fifth generation (5G) of mobile wireless communications, which provides a step change in the delivery of better and faster communications, for example powering businesses, improving communications within homes and spearheading advances such as driverless cars.

### DISCLOSURE OF INVENTION

### Technical Problem

In line with development of the communication systems, there is a need for method for distributed unstructured data-plane.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

A communication system comprises at least one unstructured data storage function, UDSF, node, wherein the at least one UDSF node comprises an Unstructured Data Storage Manager, UDSM, configured as a first functional entity; and an Unstructured Data Storage Repository, UDSR, operably coupled to the UDSM and configured as a plurality of individual data stores that form a distributed unstructured data-plane database that is managed by the UDSM.

Recently, 5G has become the network of choice due to its high performance and reliability. In future, the enterprise use cases, such as, connected vehicles, real-time automation, social connectivity and autonomous robotics will become primary driver for 5G growth [8]. A sixth generation (6G) wireless communication standard is currently under development, as the planned successor to 5G, and will likely be significantly faster. Like its predecessors, 6G networks will likely be broadband cellular networks, in which the service area is divided into small geographical areas referred to as cells. 6G networks are expected to be even more diverse than their predecessors and are likely to support applications beyond current mobile use scenarios, such as virtual and augmented reality (VR/AR), ubiquitous instant communications, pervasive intelligence and the Internet of Things (IoT). This will put tremendous pressure on the underlying infrastructure, especially the data-plane, as far as the volume of the data to be handled is considered.

To address the issue of handling large amount of user related data, 3GPP in its technical specifications TS 29.504 [1], and TS 29.598 [2] define the data-plane for service-based architecture (SBA) in 5G core [9], by providing technical specifications for Unified Data Repository (UDR) services and Unstructured Data Storage Function (UDSF) services. UDR and USDF act as data storehouse for 5G core, by storing all required data to execute 5G procedures and provide end-to-end services to all types of its supported users.

Referring to FIG. 1, a known simplified Data Storage Architecture 100 with a UDR 110 is illustrated. As mentioned in TS 23.501 [3], the 5G system architecture allows the Unified Data Management (UDM) 102, Policy Control Function (PCF) 104 and network exposure function (NEF) 106 to store data 114 in the UDR 110, including subscription data and policy data by UDM 102 and PCF 104, structured data for exposure and application data (including Packet Flow Descriptions (PFDs) for application detection, AF request information for multiple UEs) by the NEF 106. The UDR 110 is the network entity in the 5G Core Network (5GC) supporting the following functionalities via various services offered by UDS explained in [1]: storage and retrieval of subscription data as specified in 3GPP TS 29.505 [4]; storage and retrieval of policy data as specified in 3GPP TS 29.519 [5]; storage and retrieval of structured data for exposure as specified in 3GPP TS 29.519 [5]; storage and retrieval of application data (including Packet Flow Descriptions (PFDs) for application detection, application request information for multiple UEs) as specified in 3GPP TS 29.519 [5]; and subscription to notification and the notification of subscribed data changes.

Referring now to FIG. 2, a known simplified Unstructured Data Storage Architecture UDSF 200 is illustrated. Currently, any of the 5G NFs 210 is able to make use of the UDSF 220 to store and retrieve unstructured data, i.e., data that is not defined in 3GPP specifications. The UDSF 220 is deployed in the same network where the requesting NF is located and the same UDSF 220 may be shared by all the NFs 210 in the Public Land Mobile Network (PLMN) to store/retrieve their respective data, or an NF 210 may have its own UDSF 220 depending on operator configuration ([2], [3]).

As described in [6], the Network Function (NF) Repository Function (NRF) is the network entity in the 5G Core Network (5GC) supporting the following functionality: it maintains the NF profile of available NF instances and their supported services; it allows other NF instances to subscribe to, and get notified about, the registration in NRF of new NF instances of a given type; it supports service discovery function. It receives NF Discovery Requests from NF instances, and provides the information of the available NF instances fulfilling certain criteria (e.g., supporting a given service). As described in [6], UDR 110 and UDSF 220 register themselves with NRF using its Nnrf_NFManagement service. Other NFs (such as UDM, PCF, AMF, SMF etc.) discover services offered by UDR 110 and UDSF 220 via Nnrf_NFDiscovery service offered by NRF.

With exponentially increasing user demands and data volume, data division amongst servers becomes imperative, especially if the data volume cannot be stored and handled by a single server. In addition to this, with the adaption of cloud computing and edge computing technologies in 5G core, massively scalable databases have become a necessity for 5G and future 6G core. For example, a high-end storage server (for example storage server from IBM) can efficiently store up to 50 TB of data, after which, it is desired to have another server for efficient database operations [10]. Generally, in practice, though, data may be split among various servers even at the lower scale, especially with the advent of edge-computing, where resource available may be limited and hence database size could be significantly lower [11].

To achieve database scalability, generally, database is divided (either horizontally or vertically) and stored at different machines. Formally this method is called as ‘Sharding’ of the database, and it is a method for distributing a single dataset across multiple databases, which can then be stored on multiple machines. This allows for larger datasets to be split into smaller chunks and stored in multiple data servers, increasing the total storage capacity as well as scalability of the system. By distributing the data across multiple machines, a sharded database can handle more requests than a single machine can.

Sharding is a database architecture pattern related to horizontal partitioning-the practice of separating one table's rows into multiple different tables, known as partitions. Each partition has the same schema and columns, but also entirely different rows. Likewise, the data held in each is unique and independent of the data held in other partitions. It can be helpful to think of horizontal partitioning in terms of how it relates to vertical partitioning. In a vertically-partitioned table, entire columns are separated out and put into new, distinct tables. The data held within one vertical partition is independent from the data in all the others, and each holds both distinct rows and columns. Sharding is a form of scaling known as horizontal scaling or scale-out, as additional nodes are brought on to share the load, instead of adding more resources to a single node. [11]. If such data nodes are geographically distributed, then such an implementation of the data store is also called as the distributed data store or distributed databases.

With the advent of edge computing and network function virtualization (NFV), it is quite frequent to have fragmented resources or limited resources at a few deployment sites, especially after initial deployments of network functions. FIG. 3 illustrates a known simplified architecture 300 of an inefficient deployment of a UDSF with three deployment areas, where one is a core cloud location 310 with two large capacity servers 312, 314 and two smaller edge cloud locations 320, 330 with one small capacity 325, 335 server each. For simplicity, let us consider only a single combined and normalized value of a resources, which could be obtained by normalizing and combining CPU, memory, storage and other resources. As shown in FIG. 3, servers 312, 314 (rectangular boxes) with solid double lines represent the servers which are already in running state. Grey areas in rectangular boxes represent consumed resources due to deployed NFs in the 5G core. The numbers represent the remaining capacities on the servers as a single normalized value. The server 316 with double dashed line represents the available server, but not in a running state (sleep mode). Hence, server 316 has all of its resources available. It is noteworthy that running servers actively consumes resources (such as CPU, memory and storage), and have cost and energy footprints. However, servers in sleep mode, have very low energy and cost footprints as they do not consume any resource actively. Transforming such servers to running mode may be performed if extra resources are needed.

In a scenario where a new (unstructured) storage needs to be deployed (due to additional UEs joining the network) in 5G core, which demands 40 resources for actual storage (shown with hashed fill), the storage 340 is generally implemented using UDSF for unstructured data. As per the current specifications, an administrator must start the server that is currently in sleep mode at the core, which has capacity to accommodate the demands of the new storage. This will result in the higher resource utilization resulting in higher cost and energy footprint for 5G core deployment.

UDSF is a true enabler for stateless, cloud-native implementation for 5G/6G core, as it stores wide range of data and enables true service-based stateless implementation of 5G and 6G core. 3GPP describes in brief how UDR can divide the data and inform NRF about the ranges of the data a particular UDR instance is storing (for example supiRanges, gpsiRanges, in 6.1.6.2.6) [6]. The requesting NF (such as UDM) based on the range of the record, may contact respective UDR. However, there is no such provision for the storage and division of the unstructured data store in 5G/6G core. In case of load-balancing, where multiple instances of UDSF nodes are needed, there are no guidelines on how the data is divided among the UDSF nodes, which controller function keeps track of the data division and handles addition/removal of UDSF nodes in the core network. Therefore, it is left up to the requesting NF to determine the correct UDSF instance for the desired data. This may severely hamper the performance of overall core.

In a first aspect, a communication system comprises unstructured data storage service, UDSF node, wherein functionality of the UDSF node is divided into two functional entities with respective responsibilities, a first functional entity is an Unstructured Data Storage Manager (UDSM) operably coupled individually to a plurality of second functional entities that individually provide an Unstructured Data Storage Repository (UDSR) that form a distributed unstructured data-plane database.

In this manner, the communication system (e.g., a 5G/6G core) may deploy the proposed distributed unstructured data-plane efficiently, with UDSRs being actual data stores and UDSM managing UDSRs (e.g., adding/deleting UDSRs).

In an optional example, the UDSM employs sharding to load-balance data across the plurality of UDSRs. In an optional example, the UDSM employs horizontal hash-based sharding (sometimes also referred to as key-based sharding) to distribute one or more datasets across multiple databases contained within the plurality of UDSRs. Horizontal sharding can be implemented using other techniques, such as Range-based horizontal sharding and Dictionary-based horizontal sharding. In some examples, the methodology for selection of shard changes may be based according to the implementation and operational circumstances.

In an optional example, UDSM may be configured to implement and manage data in an unstructured database of 5G/6G core.

In an optional example the UDSM is configured to be operably coupled to a plurality of network functions (NFs) and configured to divide up incoming data from requesting NFs to store the unstructured divided up data in a plurality of UDSRs, for example in a 5G-6G core. This removes the overheads from a requesting NF of selecting the appropriate shard to obtain the desired data and perform their core tasks more efficiently.

In an optional example, a hierarchical implementation of UDSM and UDSR is described. For example, a single UDSF may be divided into a UDSM and UDSRs and then perform hierarchical deployment of further UDSM and UDSRs, whilst the first USDM is managing the data at the first plurality of UDSRs.

In an optional example, UDSM may be operably coupled to one or more Network Repository Function (NRF) configured to maintain profiles of UDSM, using an NRF interface, Nnrf_NFManagement. UDSM may also be configured to subscribe for additional notifications, for example in a context of discovery of UDSRs. With this subscription, the UDSM will receive notifications and details whenever a UDSR registers, deregisters or updates itself with a NRF. In an optional example, the UDSM may also be configured to unsubscribe for a status notification subscription related to UDSR, just like other services. In an optional example, NFStatusSubscribe: subscription to notifications on UDSR instances may be executed by creating a new individual resource under a collection resource of subscriptions. In an optional example, the UDSM may also be configured to subscribe for UDSR instances in the same PLMN.

In an optional example, the UDSRs are configured to communicate with NRFs using an NRF interface, Nnrf_NFManagement. In some examples, a UDSR may be configured to register itself in the NRF via a NFRegister interface by providing its NF profile to the NRF, and the NRF marks a requesting UDSR NF as available to be discovered by other NFs.

In an optional example, the UDSM may be configured to use a NFStatusNotify interface to notify each UDSM service consumer that was previously subscribed to receiving notifications of registration/deregistration of UDSR instances, or notifications of changes of the NF profile of a given NF instance.

In an optional example, the UDSM may be configured to expose (or implement) a Nudsm interface when communicating with any NF or vice versa.

In an optional example, each of the plurality of UDSRs are configured to expose (or implement) a Nudsr interface when communicating with any NF or vice versa.

In an optional example, a single instance of UDSM may comprise two deployments of UDSMs, a first UDSM configured to operate as a master UDSM and a second UDSM configured to operate as a slave UDSM in master-slave implementation, for example to provide resiliency in case master UDSM fails.

In an optional example, methodology is described for a UDSM to fulfil requests from other NFs (requesting NF) for unstructured data in 5GC/6GC.

In a second aspect, an Unstructured Data Storage Manager (UDSM) is described.

In a third aspect, an Unstructured Data Storage Repository (UDSR) is described.

In a fourth aspect, a method for deploying a distributed unstructured data-plane efficiently is described, for example for a 5G/6G core. In some examples, the method may perform load-balancing between UDSRs by a UDSM when distributing unstructured data-plane data.

In the above manners, the concepts described may enable existing 5G core or future 6G core to handle the required data rate and volume, where the data is extremely heterogeneous, with massive number of CRUD operations and extra-low latency (10 μs-1 ms). In some examples, the concepts described may enable 5G/6G core to leverage the edge resources more efficiently. In this manner, a distributed and resilient unstructured data-plane implementation in 5G/6G core may be provided. In this manner, a core may be enabled to exploit the edge resources to store the data close to the edge for faster response time. In this manner, the total storage capacity may be increased as well as scalability of the 5G/6G core system.

### Advantageous Effects of Invention

The present disclosure provides an effective and efficient method for distributed unstructured data-plane. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

Further details, aspects and embodiments will be described, by way of example only, with reference to the drawings. In the drawings, similar reference numbers are used to identify like or functionally similar elements. Elements in the figures are illustrated for simplicity and clarity and have not necessarily been drawn to scale.

FIG. 1 illustrates a known simplified Data Storage Architecture UDR.

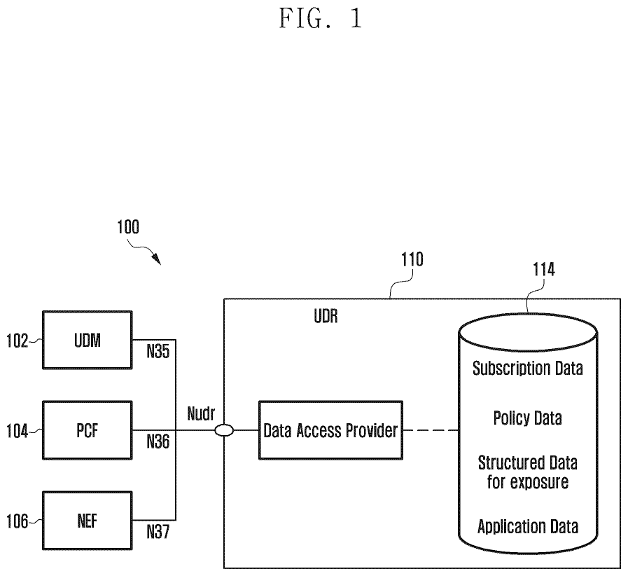

FIG. 2 illustrates a known simplified Data Storage Architecture UDSF.

FIG. 3 illustrates a known simplified architecture of an Inefficient deployment of a UDSF with three deployment areas, where one is a core cloud location with two large capacity servers and two smaller edge cloud locations with one small capacity server each.

FIG. 4 illustrates a 3GPP 5G communication system of a UDSF split into hierarchical implementation of UDSM and UDSR, adapted in accordance with some example embodiments.

FIG. 5 illustrates an updated 3GPP 5G communication system core with UDSM and UDSRs, adapted in accordance with some example embodiments.

FIG. 6 illustrates an efficient distributed database deployment using the proposed methodology of a UDSF split into hierarchical implementation of UDSM and UDSR, in accordance with some example embodiments.

FIG. 7 illustrates a simplified message sequence chart of one example of a UDSR Instance Registration/Update to NRF.

FIG. 8 illustrates a simplified message sequence chart of one example of a UDSR Instance Partial Update to NRF.

FIG. 9 illustrates a simplified message sequence chart of one example of a UDSR Instance Deregistration to NRF.

FIG. 10 illustrates a simplified message sequence chart of one example of a subscription to UDSM Instances in the same PLMN, in accordance with some example embodiments.

FIG. 11 illustrates a simplified message sequence chart of one example of a notification from NRF to UDSM about UDSR in the same PLMN, in accordance with some example embodiments.

FIG. 12 illustrates one examples of an end-to-end process scenario of UDSM/UDSR registration and to retrieve data from UDSM-UDSR in the proposed unstructured data-plane, in accordance with some example embodiments.

FIG. 13 illustrates a proposed core architecture with UDSM and UDSRs (as compared to the existing architecture of UDSF shown in FIG. 2), in accordance with some example embodiments.

FIG. 14 illustrates a resource URI structure of the nudsf-dr API specifying where a known presence of substriptiold and recordId could be used to shard the data.

FIG. 15 illustrates a simplified message flow diagram that includes a hash Allocation to Nodes and records in a load-balancing and data sharding algorithm using hash-based horizontal sharding technique, in accordance with some example embodiments.

FIG. 16 illustrates a simplified message flow diagram of a timing diagram in a first scenario, in a load-balancing and data sharding algorithm, in accordance with some example embodiments.

FIG. 17 illustrates a flow diagram of an addition of a new UDSR node, in accordance with some example embodiments.

FIG. 18 illustrates a flow diagram of a removal of an existing UDSR node, in accordance with some example embodiments.

FIG. 19 illustrates a flow diagram of a timing diagram in a second scenario in a load-balancing and data sharding algorithm, in accordance with some example embodiments.

FIG. 20 illustrates a simplified message sequence chart of one example of a direct response to the requesting NF, in accordance with some example embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various embodiments. It will be further appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### MODE FOR THE INVENTION

With the increasing penetration of 5G and to enable the 6G, the inventors have recognised and appreciated that a distributed database implementation for 5G/6G core is imperative. Hence, in examples described herein, a method and apparatus for efficient, resilient and distributed deployment of the unstructured data-plane and its management in 5G/6G core are described. Some examples update existing of implementation of UDSF in 3GPP and introduce a set of new interfaces between UDSR-NRF as well as propose updates to existing interfaces to be implemented between UDSR-UDSM and UDSM-NRF.

The current 3GPP standard specification of UDSF does not support implementation of unstructured data-plane using distributed database. In current standards, there is no provision for the implementation of distributed database, that is, dividing the data among multiple servers. Such rigid design may prevent existing 5G core or future 6G core from handling the required data rate and volume, where the data is extremely heterogeneous, with massive number of CRUD operations and extra-low latency (10 μs-1 ms) as well as prevent the core from leveraging the edge resources [8, 10].

Examples herein described propose alternative network functions to UDSF by splitting its functionality in two parts, which are: (a) Unstructured Data Storage Repository (UDSR) and (b) Unstructured Data Storage Manager (UDSM).

Examples herein described propose methodology for UDSM to implement unstructured database of 5G/6G core. In particular, examples herein described propose: (i) a distributed database model at UDSRs, to distribute the unstructured database (database maintained by existing UDSF) to various servers, rather than having a single server, for better efficiency and resiliency; (ii) a resilient database using consistent hashing and (iii) a use of sharding of the data at UDSRs using horizontal hash-based sharding.

Examples herein described propose hierarchical implementation of UDSM and UDSR. Specifically, it is proposed to split single UDSF into UDSM and UDSRs and then perform hierarchical deployment of UDSM and UDSRs, while USDM managing the data at UDSRs.

Examples herein described also propose alternative network functions to UDSF by splitting its functionality in two parts, which are: (a) Unstructured Data Storage Repository (UDSR) and (b) Unstructured Data Storage Manager (UDSM). This will enable the 5G/6G core to deploy the proposed distributed unstructured data-plane efficiently, with UDSRs being actual data stores and UDSM managing UDSRs (addition/deletion), actual data sharding and fulfilling requests from other NFs for unstructured data in 5G-6G core. This removes the overheads from the requesting NF of selecting the appropriate shard to get the desired data and perform their core tasks more efficiently.

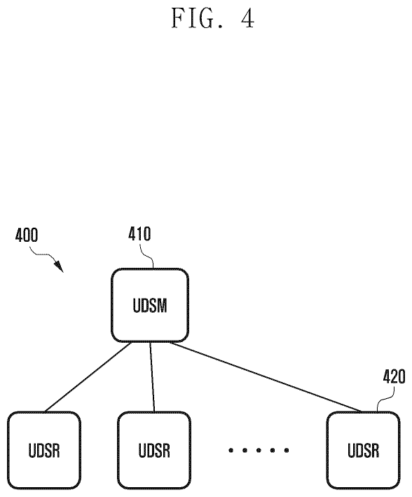

Examples herein described also propose hierarchical deployment of UDSM and UDSR. Specifically, examples herein described propose to split single UDSF into UDSM and UDSRs and then perform hierarchical deployment of UDSM and UDSRs (FIG. 4).

Although examples herein described refer to devices and nodes and circuits and/or signal processors in terms of “functions”, e.g., with regard to network functions (NF) or network requesting functions (NRFs), such phraseology is only used to apply a meaning to the terminology that is currently prevalent in the 5G/6G standards. It will be appreciated by skilled artisans that such ‘functions’ may encompass or apply equally to processor operations carried out in a wide range of devices and nodes in a communication system.

Examples herein described also refer to UDSRs as containing a plurality of individual data stores, or that are a plurality of individual data stores, with both meanings and interpretations used interchangeably. Examples herein described focus on a UDSR (that contains or is a plurality of individual data stores) being operably coupled to a UDSM, where together they form a distributed unstructured data-plane database that is managed by the UDSM.

Examples herein described also propose methodology for UDSM to handle the multiple instances of UDSRs to implement distributed database using sharding of the data at UDSRs (horizontal hash-based sharding) and distribute the data among UDSR instances.

Examples herein described also propose methodology for UDSM to enable 5GC/6GC to add/remove UDSR instances dynamically.

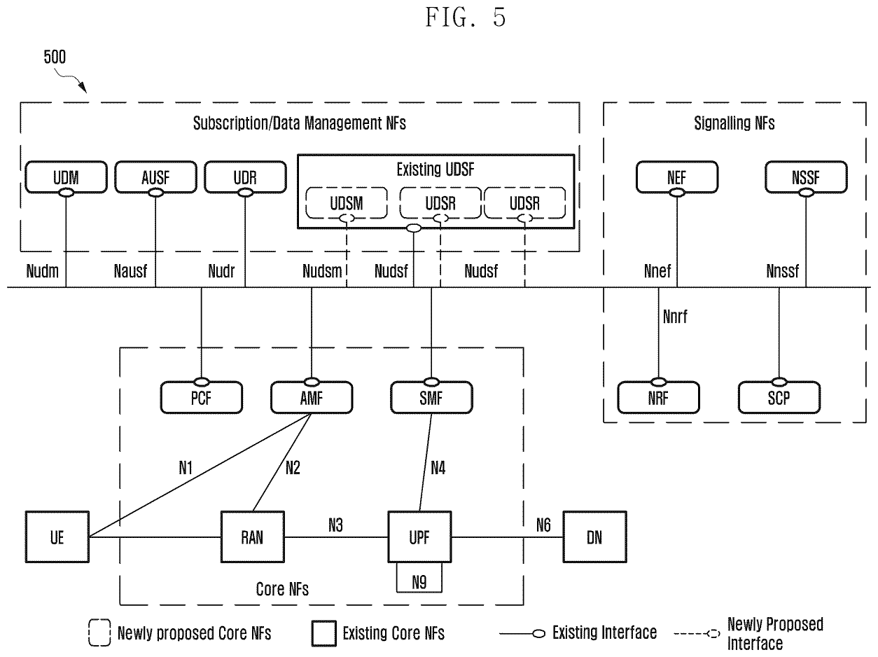

FIG. 4 illustrates a 3GPP 5G communication system 400 of a UDSF split into hierarchical implementation of Unstructured Data Storage Manager (UDSM) 410 and Unstructured Data Storage Repository (UDSR) 420, adapted in accordance with some example embodiments, as described with reference to FIG. 5.

FIG. 5 illustrates an updated 3GPP 5G communication system 500 core with UDSM and UDSRs and their respective interfaces, adapted in accordance with some example embodiments.

UDSRs will be responsible for actually storing data with sharding for efficiency, if needed. UDSM will collect the information about the available UDSRs from NRF. UDSM will then divide the incoming data (from requesting NFs with data insert/update requests) using hash-based sharding technique among available UDSRs. UDSM will also be the interface available to other NFs in 5G/6G core to access the unstructured data (that is, requesting NFs will be agnostic of NDSRs).

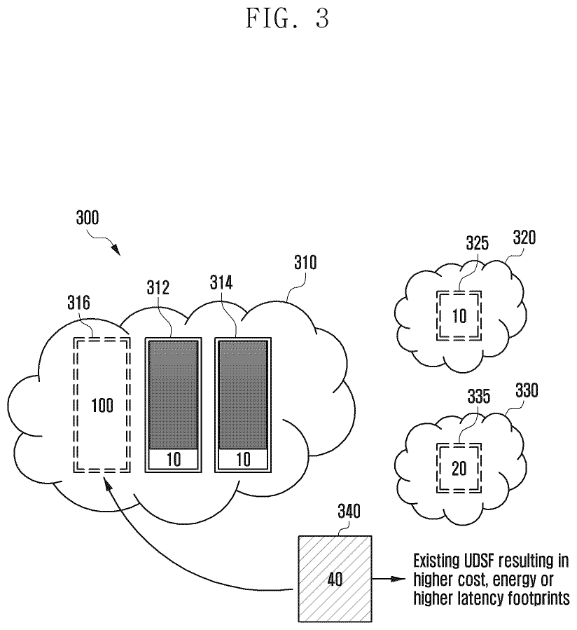

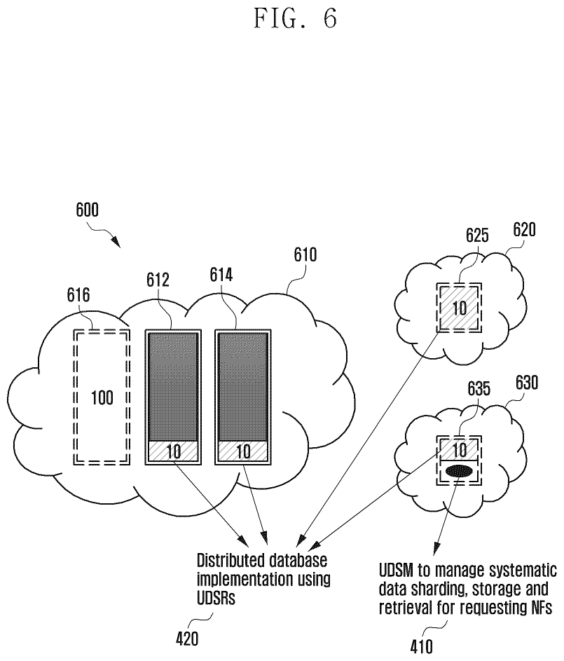

Referring now to FIG. 6, an efficient distributed database deployment 600 using the proposed methodology of a UDSF split into hierarchical implementation of UDSM 410 and UDSR 420 is illustrated, in accordance with some example embodiments. The scenario presented below highlights the advantages of the proposed framework vis-à the methodology currently possible with the existing framework as described with reference to FIG. 3. Again, in FIG. 6, a deployment of a UDSF includes three deployment areas 610, 620, 630, where one is a core cloud location 610 with two large capacity servers 612, 614 and two smaller edge cloud locations 620, 630 with one small capacity server each, 625, 635.

With the advent of edge computing and network function virtualization (NFV), it is quite frequent to have fragmented resources or limited resources at a few deployment sites, especially after initial deployments of network functions. For simplicity, examples herein described consider only a single combined and normalized value of a resources, which could be obtained by normalizing and combining CPU, memory, storage and other resources. Again, servers are shown as rectangular boxes with solid double lines represent the servers which are already in running state. Grey areas in rectangular boxes represent consumed resources due to deployed NFs in the 5G core. The numbers represent the remaining capacities on the servers as a single normalized value. The server with double dashed line represents the available server, but not in a running state (sleep mode). Hence, it has all of its resources are available. Please note, running servers actively consume resources (like CPU, Memory and Storage), and have cost and memory footprints. However, servers in sleep mode, have very low energy and cost footprints as they do not consume any resource actively. But such servers can be transformed to running mode, if extra resources are needed. Let us assume a scenario, where, a new (unstructured) storage needs to be deployed (due to additional UEs joining the network) in 5G core, which demands 40 resources for actual storage (shown with hashed fill). In 5G core, the storage is generally implemented using UDSF for unstructured data. As per the current specifications, there is no provision for splitting the UDSF.

With the proposed methodology, however, the requested storage can be deployed over the edge and the reaming capacities of the core server using UDSRs 420, with systematic division of data using UDSRs and discovery of the data using UDSM 410. The deployment is shown in FIG. 6, which is a diagram to demonstrate advantages of some examples described herein, in 5GC/6GC. Please note, UDSM 410 is not performing actual storage, and hence, need negligible resources compared against UDSRs 420. UDSM 410 can be accommodated in the remaining capacity on the edge server as shown in FIG. 6.

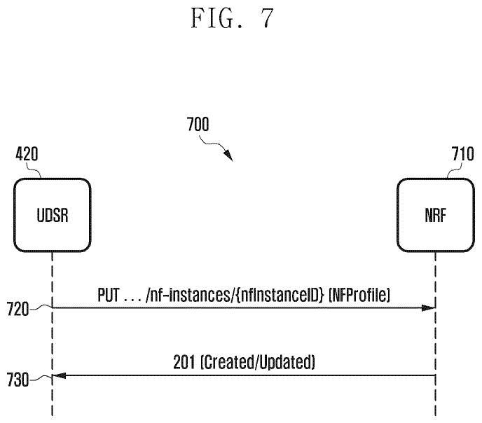

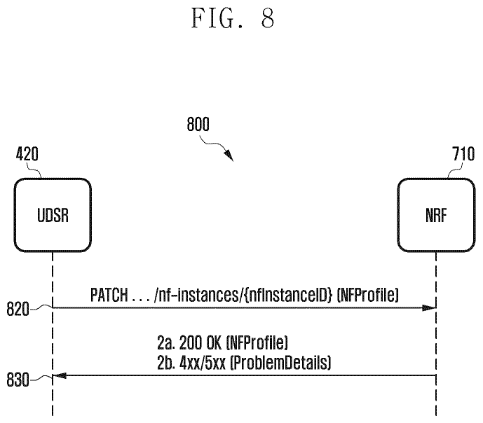

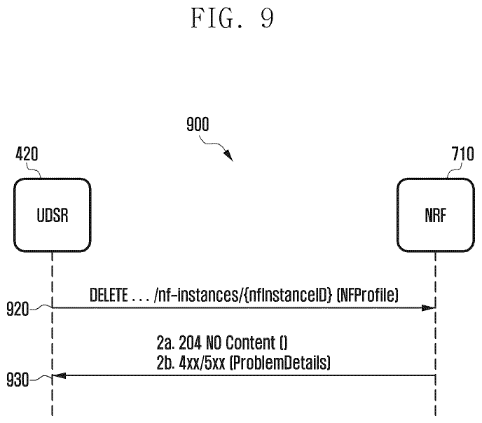

In some examples, it is envisaged that UDSRs 420 may communicate with NRF 710 using an existing interface of NRF, for example: Nnrf_NFManagement (as described in section 5.2 in [7]). In some examples, it is proposed that the UDSR 420 will only use this operation in Nnrf_NFManagement as it does not subscribe for status of any other NF Service operation. FIG. 7, FIG. 8 and FIG. 9 describe various service operation of Nnrf_NFManagement that a UDSR may use, including (but not limited to): NFRegister, NFUPdate, and NFDeRegister.

Referring now to FIG. 7, a simplified message sequence chart 700 of one example of a UDSR Instance Registration/Update to NRF is illustrated. This service operation is used by UDSR 420 to register itself in the NRF 710 by providing its NF profile to the NRF 710, and the NRF 710 marks the requesting NF as available to be discovered by other NFs. It is noteworthy that in some examples UDSRs just register their profile with NRF 710. They do not register services offered as services offered by UDSRs that will be globally known and where the UDSM 410 will be aware of them; and (ii) UDSR 420 shall send a PUT request to the resource URI representing the NF Instance, as shown in 720. The URI is determined by the NF Instance. The variable {nfInstanceID} represents an identifier, provided by the NF Service Consumer, that shall be globally unique inside the PLMN of the NRF 710 where the NF is being registered. The format of the NF Instance ID shall be a Universally Unique Identifier (UUID) version 4, as described in IETF RFC 4122, the created/updated details of which is sent 730 from the NRF 710 to the UDSR 420.

FIG. 8 illustrates a simplified message sequence chart 800 of one example of a UDSR Instance Partial Update to NRF 710, for example using a NFUPdate service operation. This service operation updates the profile of a NF previously registered in the NRF 710 by providing the updated NF profile of the requesting NF to the NRF 710. The update operation may apply to the whole profile of the NF (e.g., complete replacement of the existing profile by a new profile), or it may apply only to a subset of the parameters of the profile (including adding/deleting/replacing services to the NF profile). To perform a complete replacement of the NF Profile of a given NF Instance, the NF Service Consumer may issue an HTTP PUT request, as shown at 720 in FIG. 7.

However, in order to perform a partial update of the NF Profile of a given UDSR Instance, the UDSR may issue an HTTP PATCH request 820, as shown in FIG. 8. This partial update may be used to add/delete/replace individual parameters of the NF Instance. The updated confirmation of which is sent 830 from the NRF 710 to the UDSR 420.

FIG. 9 illustrates a simplified message sequence chart 900 of one example of a UDSR 420 Instance Deregistration to NRF. This service operation removes the profile of a UDSR previously registered in the NRF 710 using the NFDeRegister. It may be executed by deleting a given resource identified by a “NF Instance ID”. The operation is invoked by issuing a DELETE request 920 on the URI representing the specific NF Instance, as shown in FIG. 9. The updated details of which is sent 930 from the NRF 710 to the UDSR 420.

In some examples, it is envisaged that UDSM will communicate with NRF 710 exactly like existing UDSF does, in terms of discovery, services, subscription and related APIs [2, 7]. However, in accordance with examples herein described, the UDSM 410 also subscribes for additional notification, which is discovery of UDSR. With this subscription, UDSM 410 will receive notifications and details whenever UDSR 420 registers, deregisters or updates itself with NRF 710, as described in FIGS. 7-9. The UDSM 410 may also unsubscribe for this particular status notification subscription related to UDSR 420, just like other services. Additionally, in some examples, the UDSM 410 may subscribe for UDSR instances in the same PLMN though.

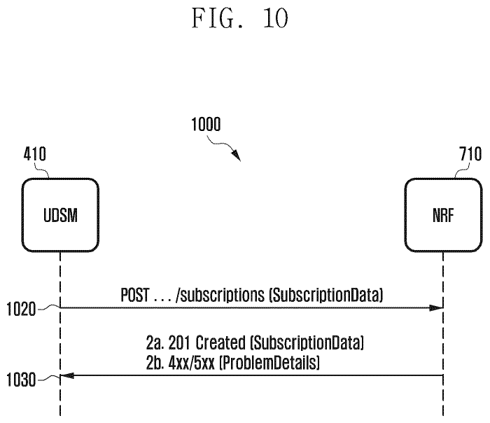

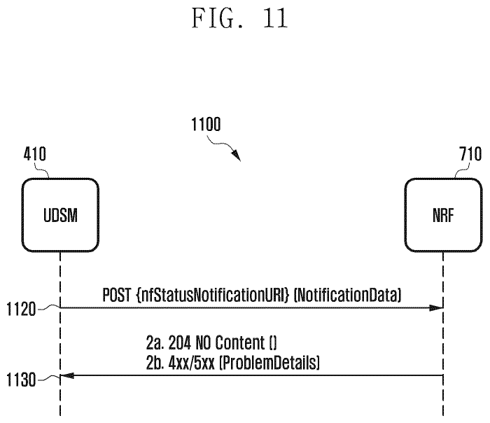

It is envisaged that additional new communications proposed between UDSM and NRF 710 may include, but are not limited to, at least NFStatusSubscribe as illustrated in FIG. 10 and NFStatusNotify as illustrated in FIG. 11. In accordance with some example embodiments one or more new interface(s) is/are provided for communication between UDSM 410 and NRF 710.

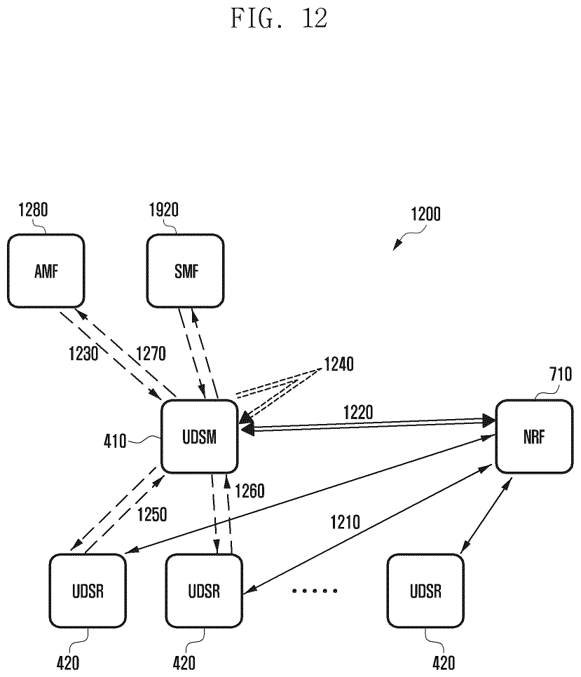

Referring now to FIG. 10, a simplified message sequence chart 1000 of one example of a subscription by UDSM to NRF about UDSR Instance updates in the same PLMN is illustrated, in accordance with some example embodiments. The subscription to notifications on UDSR Instances (using NFStatusSubscribe) may be executed at NRF by creating a new individual resource under the collection resource “subscriptions” at NRF by UDSM. The operation is invoked by issuing a POST request 1020 on the URI representing the “subscriptions” resource. The body of the POST request 1020 may include the data indicating the type of notifications that the UDSM 410 is interested in receiving; it may also contain a call-back URI 1030, where the NF Service Consumer may be prepared to receive the actual notification from the NRF 710 (see NFStatusNotify operation in FIG. 11) and it may contain a validity time, suggested by the NF Service Consumer, representing the time span during which the subscription is desired to be kept active. A corresponding flowchart is illustrated in FIG. 12.

Referring now to FIG. 11, a simplified message sequence chart 1100 illustrates a simplified message sequence chart of one example of a notification from NRF 710 to UDSM 410 about UDSR in the same PLMN, in accordance with some example embodiments. This service operation (using NFStatusNotify) notifies each UDSM 410 Service Consumer that was previously subscribed to receiving notifications of registration/deregistration of UDSR Instances, or notifications of changes of the NF profile of a given NF Instance at 1120. The notification 1120 is sent to a callback URI that each NF Service Consumer provided during the subscription. The operation is invoked by issuing a POST request to each callback URI of the different subscribed NF Instances. Thus, examples herein described propose to re-use an existing information element, IE of a NFStatusNotify but for UDSM, so that the NRF 710 is able to notify the UDSM 410 about UDSRs 420.

Referring now to FIG. 12, one example flowchart 1200 of an end-to-end process scenario to register/subscribe UDSM/UDSRs and to enable any other NF to retrieve data from UDSM-UDSR in the proposed unstructured data-plane management in 5G and 6G core is illustrated, in accordance with some example embodiments. In this example, one examples implementation of system initialization is described, whereby entities register themselves and discover about other relevant entities.

The flowchart includes communications between a number of entities, including the proposed UDSM 410, a number of UDSRs 420, requesting NFs 1280, 1920 and NRF 710. As previously mentioned, at 1220, at least a single instance of UDSM 410 is needed to enable the unstructured data-storage service in the core. In some examples, here could be single or multiple instances of UDSM 410 per PLMN, in accordance with the total load and capacities of the instances to handle the load. It is envisaged that a single instance of UDSM 410 may consist of two deployments of UDSMs 410, one as a master and one as a slave (using a standard master-slave implementation), to provide resiliency in case master UDSM 410 fails. In such case, slave will become master and spawn a new instance, as a new slave.

At 1220, the core may start with a single instance of UDSR 420, and in some examples it may be collocated with UDSM 410, at least initially. In order to spawn a new instance of UDSR 420, or stop an existing instance of UDSR 420 instance, in some examples the decision is completely up to a system monitoring agent and resource orchestrator based on existing load on the available instances of UDSRs. However, when UDSR instance boots up, it registers with NRF at 1210 (single solid lines) using NFRegister interface as illustrated in FIG. 10 and FIG. 11.

When UDSM 410 instance comes up, it registers with NRF (1220, double solid line) using standard NFRegister interface (as described with reference to FIG. 10 and FIG. 11). At the same time, UDSM 410 also subscribes to a service to get notified when UDSR instance comes up using NFStatusSubscribe, in FIG. 10. NRF notifies UDSM 410 back via NFStatusNotify, as described in FIG. 11. Also, UDSM 410 may use Nnrf_NFDiscovery service to get the information regarding existing UDSRs 420, which may have been started before UDSM instance.

In this example, both UDSM 410 and UDSR 420 also implement Heartbeat messages with NRF 710, like other NFs, as mentioned in the standard [7]. When there is no heartbeat message for a specific amount of time, NRF 710 assumes the instance is down and notifies other registered NFs of such instance, which is again already specified in [7].

When any requesting NF needs access to unstructured data (AMF 1280 or SMF 1290), it contacts UDSM using exactly the same interfaces, it would use with existing UDSF 1230 (single dashed line) [2]. The UDSM 410 then would perform internal steps (1240, double dashed line) using the proposed load-balancing and data-sharding algorithm, to select proper UDSR 420 instance, based on the range of the data requested in 1230. The request is forwarded to the appropriate UDSR 420 by UDSM 410 in 1250 (single dotted line). The UDSR 420, upon performing the requested operations, sends reply back to UDSM 410 and the UDSM 410 sends that reply back to the requesting NF at 1260, 1270 (single dotted line).

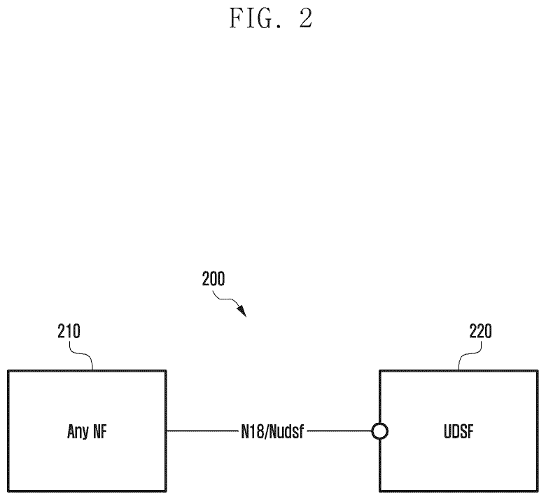

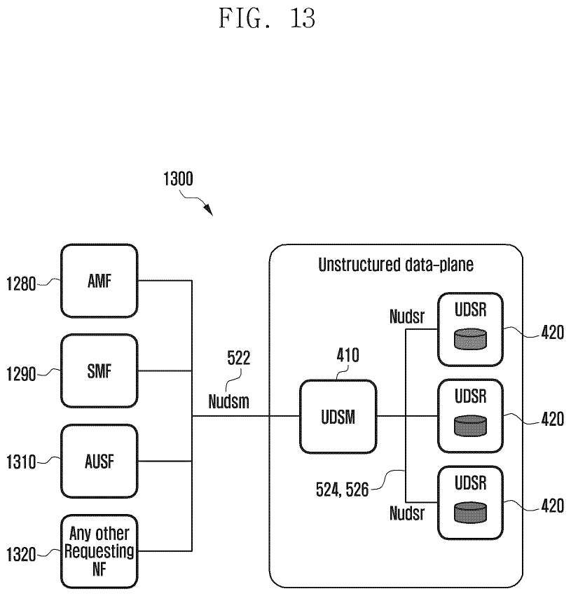

FIG. 13 illustrates a high-level drawing of a proposed core architecture 1300 with UDSM and UDSRs (as compared to the existing architecture of UDSF shown in FIG. 2), in accordance with some example embodiments. In accordance with some example embodiments one or more new interface(s) is/are provided for communication between any NF and UDSM 410 (e.g., using a new Nudsm interface 522). It is envisaged that any NF will communicate with UDSM 410 over the Nudsm interface 522 in the same manner that they communicate with UDSF over the existing N18/Nudsf interface, in order to perform various operations on the unstructured data [2].

In accordance with some example embodiments one or more new interface(s) is/are also provided for communication between UDSRs 420 and UDSMs 410 (e.g., using a new Nudsr: interface 524, 526). It is envisaged that services offered by UDSF, mentioned in Section 5 of [2] are the same services that may be offered by UDSR 420 to UDSM 410 (only) over the new interface Nudsr 524, 526. Other requesting NFs (such as AMF1280, SMF 1290, authentication server function (AUSF) 1310 responsible for security procedure for SIM authentication and/or any other requesting NF 1320), will connect to the UDSM 410 directly, in the same manner that they connect with UDSF with existing defined APIs. However, it is envisaged that they do not have to find out which shard to connect for a specific data, as the shards and their management will be abstracted by UDSM 410. In this instance, the UDSM 410 will simply forward the request to the correct UDSR 420 using the new Nudsr: interface 524, 526 and a received reply will be sent back to the requesting NF.

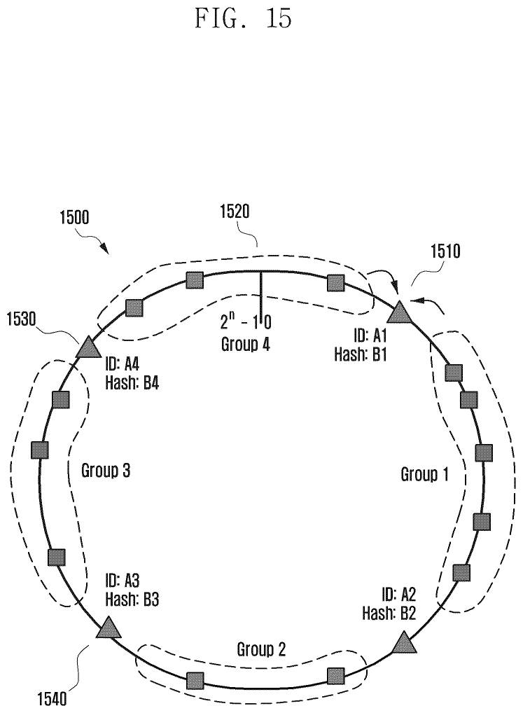

Referring now to FIG. 15, a simplified message flow diagram that includes a Hash Allocation to Nodes (UDSRs) and Data Records in a load-balancing and data sharding algorithm is illustrated, in accordance with some example embodiments In some examples, a methodology for UDSM 410 to load-balance and divide the data among UDSR 420 instances using sharding is described, e.g., how a UDSM 410 may select an UDSR 420 to store or retrieve the data and reply to the requests from other requesting NFs, that is, allocate and divide the data among UDSR 420 instances. In some examples, it is considered that a timing of such a decision may be one made by a system monitoring agent and resource orchestrator following a monitoring of existing load on the available instances of UDSRs 420, and take a decision to start a new instance or stop an existing instance of UDSR 420. However, once a new instance of UDSR 420 a methodology is proposed for UDSM 410 to perform the load-balancing among the existing instances and re-distribute the data among them. Specifically, a Hash-based horizontal sharding process is proposed as a load-balancing algorithm. In one example, the Hash-based horizontal sharding process enables the UDSM 410 to select UDSR instance to forward the requesting NF's Request Message, gather the response and send it back to the requesting NF (using a load-balancing algorithm). In one example, the Hash-based horizontal sharding process enables the UDSM 410 to manage additional and/or removal of UDSR instances and handle the redistribution of the data in such cases.

Load-balancing and data sharding algorithm:

With regard to data management in a first example, it is assumed that a system administrator starts the instance of UDSM 410 and a few instances of UDSRs 420 as per a system load in order to initialize a 5GC/6GC data-plane. Soon thereafter, the system reaches a steady state and other requesting NFs start interacting with the UDSM 410 in order to access, add or update the unstructured data. One example of such a process is described below.

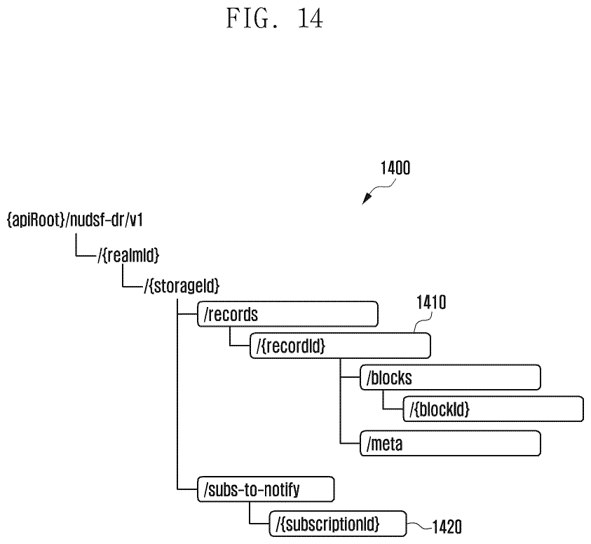

When a system for unstructured data-plane initializes, the UDSM 410 boots up. The UDSM 410 may then implement a n-bit hash function 1510 φⁿ:A→B where, A is UUID of the UDSR 420, whereby one example of a Resource URI structure of the nudsf-dr API 1400 is illustrated in FIG. 14, specifying a presence of a substriptiold 1420 and recordId 1410 (and where they reside) that are used to shard the data, already proposed in [2]. The n-bit hash function 1510 φⁿ then generates a natural number ‘B’ in a range of 2ⁿ1 1520. n may be chosen sufficiently large in a such way that 2ⁿ can cover the total number of possible entities (in this case UDSR 420 instances and total probable records in the system). Then instances of UDSRs 420 boot up and register themselves with NRF.

The UDSM 410 then receives notification from NRF that a new UDSR 420 instance has joined the system. Here, the UDSM 410 retrieves the UUID of the UDSR 420 as A and forwarding information of UDSR 420 as f(A) (such as: IPv4/IPv6 or MAC). The UDSM 410 then calculates hash B=φⁿ(A), at 1530, and the UDSM 410 locally stores the mapping B→f(A) in h such that h(B)→f(A) (h may be implemented using data-structure called as Hashmap for O(1) retrieval time). The UDSM 410 then receives a query(get) or insert/update/delete (put/patch) request as R₁ from requesting NF for some data. In this example, the UDSM 410 retrieves the NF UUID as d, forwarding information of NF as f(d) (such as IPv4/IPv6/MAC), and SRID (or range of IDs, based on the type of query) as A′ from R₁. In this example, a mapping R₁→f(d) is stored in h′. The UDSM 410 then calculates a new hash B′=φⁿ(A′) 1540. The UDSM 410 gets two values of B, that is, B₁ and B₂ from h such that B′ lies within B₁ and B₂. In this example, let us assume that the corresponding UDSR IDs be A₁ and A₂. The UDSM 410 retrieves f(A₁)=h(B₁) and f(A₂)=h(B₂). If the function is an insert/update/delete request, request is forwarded to both A₁ and A₂. Thereafter, in this example, one record is allocated to two UDSRs 420 that enables the system to be resilient in the case of UDSR failures, as some other UDSR 420 may still hold the data until the system recovers from any potential failure and re-distributes the data. The UDSF waits for confirmation from both A₁ and A₂ and then only sends success message back to requesting NF. In case of no response or failure, a UDSF may retry for a specific number of times, before sending failure back to the requesting NF. If the request is a query (get) request, then the following operations may be performed, for example: if B₁<B₂ then R₁ is forwarded to A₁ else it is forwarded to A₂; a corresponding mapping for is then stored as: R₁→A₁ (or vice-a-versa, that is, R₁→A₂; if no response is received for R₁ from A₁/A₂ within given time threshold λ, then request is forwarded to A₂/A₁ and mapping entry is updated; once response is received, response is send back to h′(R₁), that is, to NF with ID d. If both A₁ and A₂ fail to respond, then a failure code is sent back to d.

Thus, FIG. 15 explains the horizontal hash-based sharding and mapping of the records to the UDSRs 420 based on the hashes generated (in the load-balancing algorithm). As mentioned, the hash function generates hash keys from 0 to 2ⁿ−1, which are mapped on a ring. As observed in FIG. 15, four UDSRs (represented by triangles) exist in the system (let us say with IDs A₁ to A₄). UDSM 410 calculates the respective hashes for them, using their IDs (say B₁ to B₄). A same hash function is also applied to records (record IDs or SRIDs) to get hashes for each record (represent by rectangles). All rectangles and triangles are mapped on the ring. The load-balancing algorithm makes sure that each record, is assigned to two UDSRs, for example record group represented by Group 1 is allocated to UDSR 420 with hashes B₁ and B₂, that is IDs A₁ and A₂. If the end of the ring is reached, in this example it is proposed to wrap around to start over, that is records in Group 4 are allocated to UDSRs A₁ and A₄.

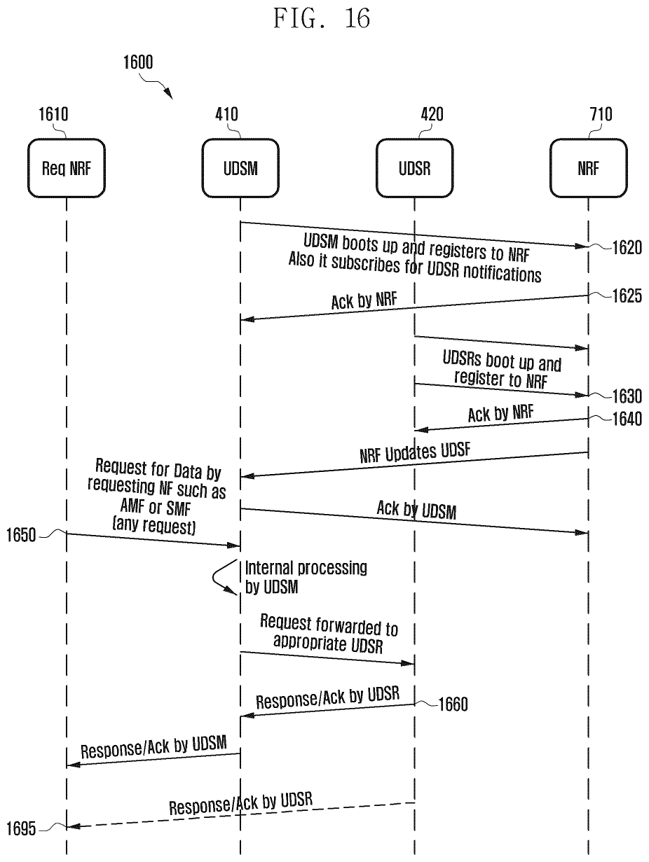

FIG. 16 illustrates a simplified message sequence chart 1600 of a timing diagram for steady state of the aforementioned first scenario using the aforementioned load-balancing algorithm, in accordance with some example embodiments. When a system for unstructured data-plane initializes, the UDSM 410 boots up and registers to the NRF 710 and subscribes for UDSR 420 notifications at 1620. The NRF 710 acknowledges this at 1625. Then instances of UDSRs 420 boot up and register themselves with NRF 710 at 1630, which are acknowledged.

The UDSM 410 then receives notification from NRF 710 that a new UDSR 420 instance has joined the system and acknowledges the same at 1640. Here, the UDSM 410 retrieves the UUID of the UDSR 420 and forwarding information of UDSR 420.

The UDSM 410 then receives a query(get) or insert/update/delete (put/patch) request as RI from requesting NRF 1610 for some data at 1650. In this example, the UDSM 410 retrieves the NF UUID as d, forwarding information of NF as f(d) (such as IPv4/IPv6), and SRID (or range of IDs, based on the type of query). In this example, a mapping is stored. Thereafter, in this example, one record is allocated and forwarded to the appropriate UDSR 420 at 1660. In case of no response or failure, an UDSM 410 may retry for a specific number of times, before sending failure back to the requesting NRF 710. Once a response is received at the UDSM 410, a response is sent back to NF 1610 at 1670 with ID d. The final dotted line 1695 between UDSR 420 and the requesting NF 1610 represents the alternate approach of direct response as mentioned in the later-described algorithm to manage additional and/or removal of UDSR instances as well as handle the redistribution of the data in such cases.

UDSR management in a second scenario:

After steady state, a situation may arise where a new instance of UDSR 420 is added or removed, when the system already has data, which is divided among the existing instances of UDSRs 420. In such case, UDSM 410 may perform the following operations to accommodate such changes. The UDSM 410 receives notification from NRF 710 that a new UDSR 420 instance has joined the system. The UDSM 410 retrieves the UUID of the UDSR 420 as A and forwards information of UDSR 420 as f(A) (such as IPv4/IPv6 or MAC). The UDSM 410 calculates hash B=φⁿ(A) UDSM locally stores the mapping B→f(A) in h such that h(B)→f(A). The UDSM 410 gets two values, B₁ and B₂ from h such that B lies within B₁ and B₂, such that, B₁<B₂. Let us assume, for example, that the corresponding UDSR IDs be A₁ and A₂. The UDSM 410 then performs following operations to re-distribute the data among A₁, A and A₂: The UDSM 410 issues a ‘Get’ request to A₁ at address f(A₁) (can be obtained from h(B₁)), to retrieve all records within whose hash codes are within the range B and B₂. A range ‘Get’ query as mentioned previously can be used for the same. The UDSM 410 issues an ‘Insert’ request to A (at address f(A)) for the retrieved records. A range ‘Put’ query as mentioned previously can be used for the same. The UDSM 410 issues a ‘Delete’ request to A₁ at address f(A₁) to delete all records for which hash codes are within the range B₁ and B. A range Update query as mentioned previously can be used for the same. A similar process may be repeated with A₂ and A for the records for which hash codes are within the range B₁ and B.

The UDSM 410 receives notification from NRF 710 that an existing UDSR 420 instance has been removed from the system (failure or scale down). The UDSM 410 retrieves the UUID of the UDSR 420 as A. The UDSM 410 calculates hash B=φⁿ(A). The UDSM 410 removed the local mapping B→f(A) from h. The UDSM 410 gets two values, B₁ and B₂ from h such that B lies within B₁ and B₂, such that, B₁<B₂. Let the corresponding UDSR IDs be A₁ and A₂. The UDSM then performs the following operations to re-distribute the data of instance A between A₁ and A₂. The UDSM 410 issues Get request to A₁ at address f(A₁) (can be obtained from h(B₁)), to retrieve all records within whose hash codes are within the range B₁ and B. A range ‘Get’ query as mentioned previously can be used for the same. The UDSM 410 issues ‘Insert’ request to A₂ (at address f(A₂)) for the retrieved records. A range ‘Put’ query as mentioned previously can be used for the same. The UDSM 410 issues ‘Get’ request to A₂ at address f(A₂) to retrieve all records within whose hash codes are within the range B and B₂. A range ‘Get’ query as mentioned previously can be used for the same. The UDSM issues ‘Insert’ request to A₁ (at address f(A₁)) for the retrieved records. A range ‘Put’query as mentioned previously can be used for the same.

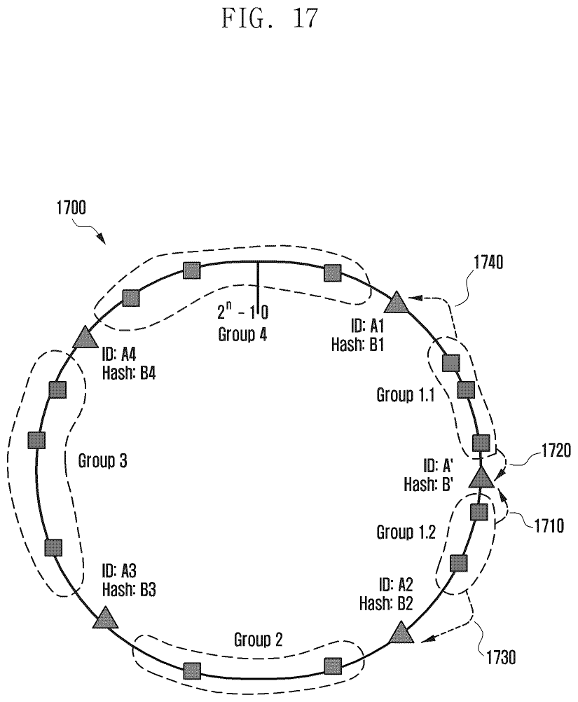

Referring now to FIG. 17, a simplified message sequence chart 1700 of an addition of a new UDSR 420 node according to a second example scenario is illustrated, in accordance with some example embodiments. Similar approaches to the illustration of FIG. 15 are adopted, with the operations not repeated to avoid obscuring the second example scenario concepts. Let's consider first a case, where a new UDSR 420 node joins the core (see the load-balancing algorithm). Let's assume the node ID is A′ and its respective hash is B′, at 1710, where B′ lies between B₁ and B₂ (that is node A₁ and A₂), as shown in FIG. 11. As shown in FIG. 17, due to addition of B′ on the ring, the group 1 of records is now divided into two parts, that is, group 1.1 1720 and group 1.2 1730. As per the load-balancing algorithm, records belonging to group 1 are removed form node A₁ and A₂. Records in group 1.1 1720 are added to node A₁ and records in group 1.2 1730 are added t node A₂ Also records in both groups 1.1 1720 and 1.2 1730 are allocated to new node A′.

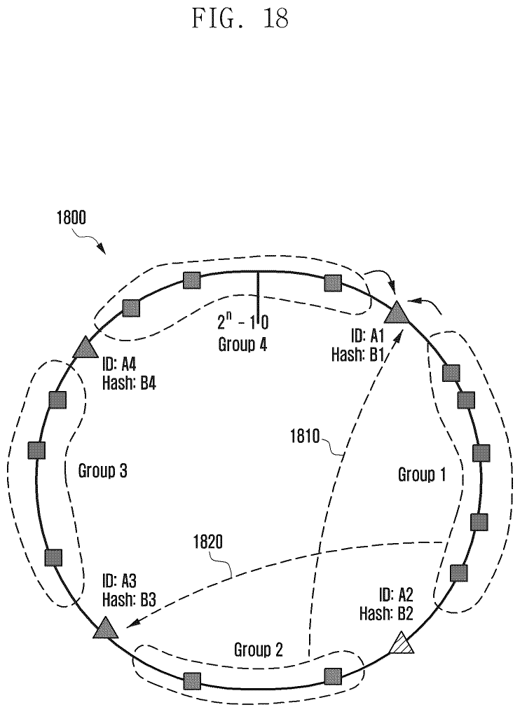

Referring now to FIG. 18, a simplified message sequence chart 1800 of a removal of an existing UDSR node according to a second example scenario is illustrated, in accordance with some example embodiments. In this example scenario, let's consider a case, where an existing UDSR 420 node shuts down (e.g., due to a failure or scaling down). As shown in FIG. 18, node A₂ shuts down. In this case, as per the corresponding operation in the load-balancing algorithm, all the records in groups are assigned to the previous node A₁ and all the records in group 1 are assigned to the next node A₃.

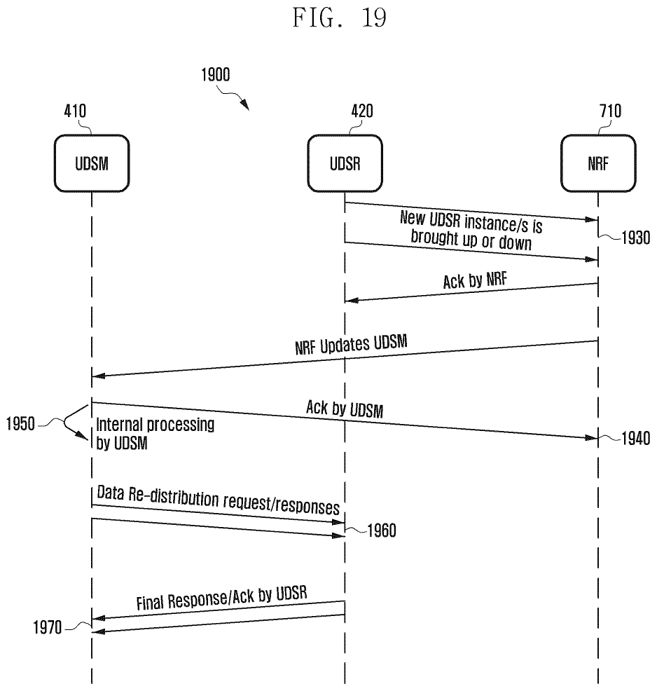

Referring now to FIG. 19 illustrates a simplified message sequence chart 1900 of a timing diagram of the second scenario using the load-balancing algorithm after steady-state according to a second example scenario is illustrated, in accordance with some example embodiments. Instances of UDSRs 420 boot up and register themselves with NRF 710 at 1930, which are acknowledged.

The UDSM 410 then receives notification from NRF 710 that a new UDSR 420 instance has joined the system and acknowledges the same at 1940. Here, the UDSM 410 performs some internal processing of the data, e.g., retrieves the UUID of the UDSR 420 and forwarding information, data records re-distribution with existing UDSRs (1730 1740 in FIG. 17 in the case of UDSR addition or 1810, 1820 in FIG. 18 in the case of UDSR deletion), data records allocation to newly added UDSR (1710, 1720 in FIG. 17) etc. Once the data re-distribution is received at the UDSR 420, a response is sent back to the UDSM 410 at 1970 with ACK (acknowledgement).

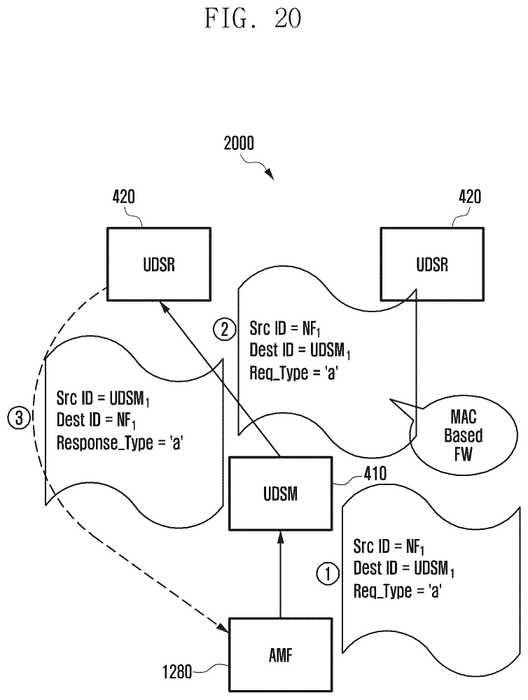

FIG. 20 illustrates a simplified message sequence chart 2000 that details a direct response to the requesting NF, in accordance with some example embodiments.

In this example, the corresponding operations in the load-balancing algorithm of: ‘when any requesting NF needs access to unstructured data (AMF or SMF), it contacts UDSM using exactly the same interfaces, it would use with existing UDSF’; and ‘the UDSM then would perform internal operations to select proper UDSR, based on the range of the data requested’ would remain the same. In this example, it is proposed to send a direct response to the requesting NF, e.g., AMF 1280 from UDSR 420 instead of response going through UDSM. This reduces significant overheads at UDSM 410 to maintain relevance between requesting NF ID and request ID (in the aforementioned load-balancing algorithm, where mapping R₁→f(d) is stored in h′), thereby improving its performance. This also makes the aforementioned operations in the load-balancing algorithm of UDSM 410 for sending reply back to requesting NF, e.g., AMF 1280, redundant.

In another example, it is proposed to modify the 1250 and 1260 in the flowchart 1200 of FIG. 12 and operation 1660 in FIG. 16. Instead, examples herein described propose step 1695 in FIG. 16 to send direct response to the requesting NF from UDSR. This reduces significant overheads at UDSM to maintain relevance between requesting NF ID and request ID in (load-balancing algorithm), improving its performance.

An algorithm is described for the UDSM to manage additional and/or removal of UDSR instances as well as handle the redistribution of the data in such cases. Here, the UDSM receives a request from requesting NF (step 1, single solid line). Examples herein described only showcase the important fields in the request send by the requesting NF, which are requesting NF (source NF) ID (it could be IPv4/IPv6), destination ID (UDSM ID, it could be IPv4/IPv6) and request type (it could be data PUT request). On receiving the request, UDSM selects the target UDSR based on the data range (please refer to load-balancing algorithm for the operations).

In some examples, the UDSM, instead of performing IP based forwarding to the relevant UDSR, UDSM performs MAC based forwarding (step 2, single solid line).

Please note the all the relevant fields in the received request remain the same (especially, source and destination IDs are not changed).

MAC based forwarding allows the UDSR to prepare a response and set the source and destination fields by reversing the relevant fields in the request frame. This enables UDSR to send a direct reply to requesting NF instead of the reply to go through the UDSM again.

It will be appreciated that, for clarity purposes, the above description has described example embodiments with reference to different functional units and processors. However, it will be apparent that any suitable distribution of functionality between different functional units or processors, for example with respect to the signal processor may be used without detracting from the concepts described herein. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects may be implemented in any suitable form including hardware, software, firmware or any combination of these. Example embodiments may optionally be implemented, at least partly, as computer software running on one or more data processors and/or digital signal processors or configurable module components such as FPGA devices. Thus, the elements and components of an embodiment may be physically, functionally and logically implemented in any suitable way. Indeed, the functionality may be implemented in a single unit, in a plurality of units or as part of other functional units.

Although the concepts have been described in connection with some embodiments, it is not intended to be limited to the specific form set forth herein. Rather, the scope is limited only by the accompanying claims. Additionally, although a feature may appear to be described in connection with particular embodiments, one skilled in the art would recognize that various features of the described embodiments may be combined in other examples. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

In accordance with examples herein described, a number of approaches are provided for the storage and division of the unstructured data store in 5G/6G core, wherein the aforementioned disadvantages with prior art arrangements have been substantially alleviated.

### ABBREVIATIONS/DEFINITIONS

In the present disclosure, the following acronyms/definitions are used.
3GPP 3^{rd} Generation Partnership Project
6G 6^{th} Generation
5G 5^{th} Generation
5GC 5G Core
5GS 5G System
ACK Acknowledge
AM Acknowledged Mode
AMF Access and Mobility Management Function
AS Access Stratum
BL Bandwidth-reduced Low-complexity
CA Carrier Aggregation
CCCH Common Control Channel
CDMA Code Division Multiple Access
CE Coverage Enhancement
CIoT Cellular IoT
CN Core Network
C-RNTI Cell RNTI
CS Circuit Switched
DC Dual Connectivity
DCCH Dedicated Control Channel
DRB Data Radio Bearer
EDGE Enhanced Data rates for Global Evolution
EDT Early Data Transmission
eMTC enhanced Machine Type Communication
EN E-UTRAN NR
eNB Base Station
EPC Evolved Packet Core
EPS Evolved Packet System
E-UTRA Evolved Universal Terrestrial Radio Access
E-UTRAN Evolved Universal Terrestrial Radio Access Network
GEO Geosynchronous Equatorial Orbit
GERAN GSM EDGE Radio Access Network
gNB 5G Base Station
GSM Groupe Special Mobile
HAPS High Altitude Platform Station
HARQ Hybrid Automatic Repeat Request
ID Identity/Identification
IE Information Element
IoT Internet of Things
LEO Lower Earth Orbit
LTE Long Term Evolution
LTE-M LTE Machine Type Communication
MAC Medium Access Control
MCG Master Cell Group
MEO Medium Earth Orbit
MME Mobility Management Entity
NAS Non Access Stratum
NB Narrow Band
BS Base Station
NG Next Generation
NR New Radio
NTN Non-Terrestrial Network
PCell Primary Cell
PDCP Packet Data Convergence Protocol
PDU Protocol Data Unit
PSCell Primary and Secondary Cells
RAN Radio Access Network
RAT Radio Access Technology
RB Radio Bearer
RLC Radio Link Control
RLF Radio Link Failure
RNTI Radio Network Temporary Identifier
ROHC Robust Header Compression
RRC Radio Resource Control
S1 Interface between RAN and CN
SAP Service Access Point
SCG Secondary Cell Group
SIB System Information Block
SRB Signalling Radio Bearer
S-TMSI Short TMSI
TAU Tracking Area Update
TM Transparent Mode
TMSI Temporary Mobile Subscriber Identity
TN Terrestrial Network
TS Technical Specification
Txxx Timer xxx
UE User Equipment
UP User Plane
X2/Xn Interface between RAN nodes.

1. A communication system comprises at least one unstructured data storage function (UDSF) node, wherein the at least one UDSF node comprises:
an unstructured data storage manager (UDSM) configured as a first functional entity; and
an unstructured data storage repository (UDSR) operably coupled to the UDSM and configured as a plurality of individual data stores that form a distributed unstructured data-plane database that is managed by the UDSM.

2. The communication system of claim 1,
wherein the communication system is one of a fifth generation (5G), a sixth generation (6G), a third generation partnership project (3GPP), or a core network,
wherein the UDSM is configured to add and delete UDSRs from the UDSF node,
wherein the UDSM is configured to employ sharding that load-balances data across the plurality of individual data stores in the UDSR,
wherein the UDSM is configured to employ horizontal hash-based sharding to distribute one or more datasets across multiple databases contained within the plurality of individual data stores in the UDSR, or
wherein the UDSM is configured to employ one of a range-based horizontal hash-based sharding or a dictionary-based horizontal hash-based sharding.

3. The communication system of claim 1, further comprising:
a plurality of network functions (NFs) operably coupled to the UDSM,
wherein the UDSM is configured to divide up incoming data from requesting NFs and store unstructured divided up data across the plurality of individual data stores of the UDSR, and thereby remove overheads from a requesting NF when it selects a shard.

4. The communication system of claim 1,
wherein a single UDSF comprises a first UDSM and a first UDSR, wherein the single UDSF is configured to perform hierarchical deployment of at least one further UDSM and at least one further UDSR, whilst the first UDSM manages data across the plurality of individual data stores at the first UDSR,
wherein the UDSM is operably coupled to at least one network repository function (NRF) that is configured to maintain profiles of a plurality of UDSMs using an NRF interface, Nnrf_NFManagement,
wherein the UDSM is configured to subscribe to notifications in a context of discovery of yet further UDSRs whenever the yet further UDSRs register, deregister or update themselves with the at least one NRF, or
wherein the UDSM is configured to subscribe to notifications in a context of discovery of yet further UDSRs by creating a new individual resource under a collection resource of subscriptions.

5. The communication system of claim 1, wherein the UDSM is configured to subscribe to notifications in a context of discovery of yet further UDSRs in the same public land mobile network, (PLMN).

6. The communication system of claim 4,
wherein the UDSR is configured to register itself in the NRF via a NFRegister interface by providing its network function (NF) profile to the NRF, and in response thereto the NRF identifies a requesting UDSR NF as being available to be discovered by other NFs, or
wherein the UDSM is configured to use a NFStatusNotify interface to notify at least one UDSM service consumer that is subscribed to receiving notifications of registration/deregistration of at least one of an UDSR that registers, deregisters or updates itself, a notification of a change of an NF profile of a NF.

7. The communication system of claim 1, wherein the UDSM is configured to implement a Nudsm interface when communicating with a network function (NF).

8. The communication system of claim 1, wherein at least one of the plurality of individual data stores of the UDSR is configured to implement a Nudsr interface when communicating with a network function (NF).

9. The communication system of claim 1, wherein a single UDSM is configured to deploy two UDSMs, a first UDSM configured to operate as a master UDSM and a second UDSM configured to operate as a slave UDSM in a master-slave implementation.

10. An unstructured data storage manager (UDSM) configured as a first functional entity in an unstructured data storage function (UDSF) node and configured to be operably coupled to an unstructured data storage repository (UDSR) that comprises a plurality of individual data stores that form a distributed unstructured data-plane database that is managed by the UDSM.

11. The UDSM of claim 10,
wherein the UDSM is configured to add and delete UDSRs from the UDSF node,
wherein the UDSM is configured to employ sharding that load-balances data across the plurality of individual data stores in the UDSR,
wherein the UDSM is configured to employ horizontal hash-based sharding to distribute one or more datasets across multiple databases contained within the plurality of individual data stores in the UDSR, or
wherein the UDSM is configured to employ one of a range-based horizontal hash-based sharding or a dictionary-based horizontal hash-based sharding.

12. The UDSM of claim 10,
wherein the UDSM is configured to be operably coupled to a plurality of network functions (NFs) and the UDSM is configured to divide up incoming data from requesting NFs and store unstructured divided up data across the plurality of individual data stores of the UDSR, and thereby remove overheads from a requesting NF when it selects a shard,
wherein the UDSM is operably coupled to at least one network repository function (NRF) that is configured to maintain profiles of a plurality of UDSMs using an NRF interface, Nnrf_NFManagement, or
wherein the UDSM is configured to subscribe to notifications in a context of discovery of yet further UDSRs whenever the UDSR registers, deregisters or updates itself with the at least one NRF.

13. The UDSM of claim 10,
wherein the UDSM is configured to subscribe to notifications in a context of discovery of yet further UDSRs by creating a new individual resource under a collection resource of subscriptions, or
wherein the UDSM is configured to subscribe to notifications in a context of discovery of yet further UDSRs in the same public land mobile network (PLMN).

14. A method for deploying a distributed unstructured data-plane in a communication system that comprises at least one unstructured data storage function (UDSF) node, wherein the at least one UDSF node comprises an unstructured data storage manager (UDSM) operably coupled to an unstructured data storage repository (UDSR), the method comprising:
configuring the UDSM, as a first functional entity;
configuring the UDSR as a plurality of individual data stores that form a distributed unstructured data-plane database; and
managing the UDSR and the plurality of individual data stores that form a distributed unstructured data-plane database by the UDSM.

15. The method of claim 14, further comprising:
performing a load-balancing between the plurality of individual data stores of the UDSR by the UDSM when distributing unstructured data-plane data.
